(19) United States
(12) Patent Application Publication
(10) Pub. No.: US 2015/0312438 A1
(43) Pub. Date: Oct. 29, 2015

(54) IMAGE PROCESSING DEVICE

(71) Applicant: KABUSHIKI KAISHA TOSHIBA, Minato-ku (JP)

(72) Inventors: Yukiyasu TATSUZAWA, Kanagawa (JP); Kazuhiro HIWADA, Kanagawa (JP); Tatsuji ASHITANI, Kanagawa (JP)

(73) Assignee: KABUSHIKI KAISHA TOSHIBA, Minato-ku (JP)

(21) Appl. No.: 14/790,899

(22) Filed: Jul. 2, 2015

Related U.S. Application Data
(62) Division of application No. 13/890,382, filed on May 9, 2013.

(30) Foreign Application Priority Data
Dec. 4, 2012 (JP) 2012-265106

(51) Int. Cl. H04N 1/21; H04N 5/376; H04N 5/357

(52) U.S. Cl. CPC H04N 1/2104; H04N 5/357; H04N 5/3765

(57) ABSTRACT

According to one embodiment, an image processing device includes a line memory that stores an input image by a plurality of rows; a defect correcting circuit that performs defect correction on the input image based on image data stored in the line memory; a binning circuit that generates a low pass image having a lower spatial frequency than the input image by binning the input image subjected to the defect correction; a frame buffer that stores the low pass image; a filter that generates a high pass image having a higher spatial frequency than the low pass image by filtering the input image subjected to the defect correction; and a mixing circuit that mixes the low pass image with the high pass image.

### CROSS-REFERENCE TO RELATED APPLICATIONS

This application is a divisional of U.S. application Ser. No. 13/890,382 filed May 9, 2013, which is based upon and claims the benefit of priority from Japanese Patent Application No. 2012-265106, filed on Dec. 4, 2012; the entire contents of both of which are incorporated herein by reference.

### FIELD

Embodiments described herein relate generally to an image processing device.

### BACKGROUND

In a CMOS image sensor, there is a method of using a multi-resolution filter to remove noise of an input image. In the method of using the multi-resolution filter, an effective filter diameter in a low pass can be enlarged by generating a reduced image from the input image, thereby reducing a memory capacity.

### BRIEF DESCRIPTION OF THE DRAWINGS

FIG. 1 is a block diagram illustrating an overall configuration of an image processing device according to a first embodiment;

FIG. 2 is a diagram illustrating an image processing method for the image processing device illustrated in FIG. 1;

FIG. 3 is a block diagram illustrating an overall configuration of an image processing device according to a second embodiment;

FIG. 4 is a diagram illustrating an image processing method according to a third embodiment;

FIG. 5 is a diagram illustrating an image processing method according to a fourth embodiment;

FIG. 6 is a diagram illustrating an image processing method according to a fifth embodiment;

FIG. 7 is a diagram illustrating an image processing method according to a sixth embodiment;

FIG. 8 is a diagram illustrating an image processing method according to a seventh embodiment; and

FIG. 9 is a block diagram illustrating an overall configuration of a video camera to which an image processing device according to an eighth embodiment is applied.

### DETAILED DESCRIPTION

In general, according to one embodiment, a line memory, a defect correcting circuit, a binning circuit, a frame buffer, a filter, and a mixing circuit are provided. The line memory stores an input image by a plurality of rows. The defect correcting circuit performs defect correction on the input image based on image data stored in the line memory. The binning circuit generates a low pass image having a lower spatial frequency than the input image by binning the input image subjected to the defect correction. The frame buffer stores the low pass image. The filter generates a high pass image having a higher spatial frequency than the low pass image by filtering the input image subjected to the defect correction. The mixing circuit mixes the low pass image with the high pass image.

Hereinafter, an image processing device according to embodiments will be described in detail with reference to the appended drawings. The invention is not limited to the embodiments.

### First Embodiment

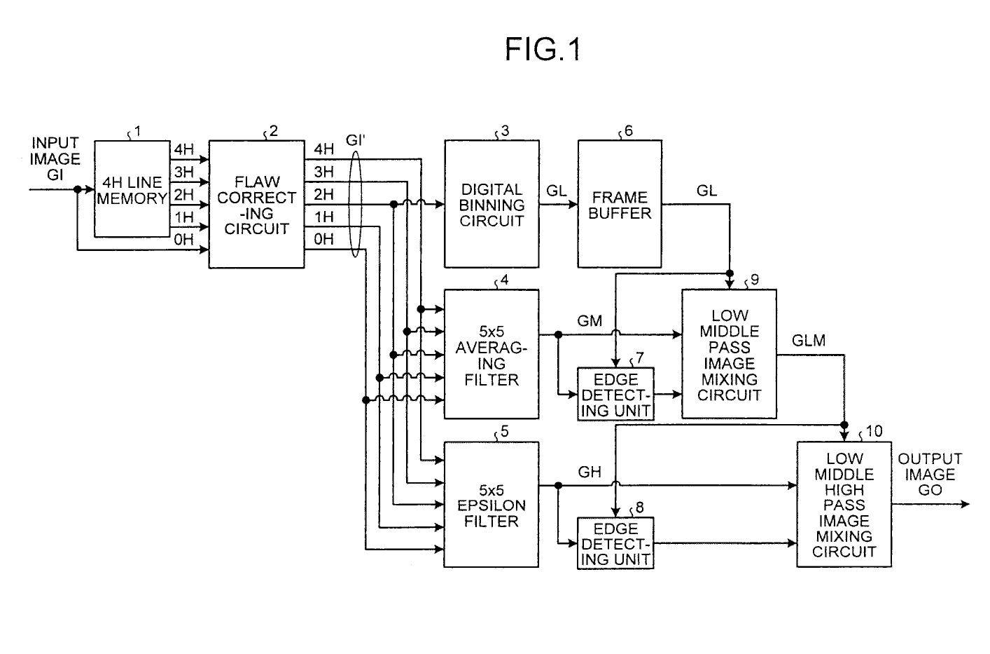

FIG. 1 is a block diagram illustrating an overall configuration of an image processing device according to a first embodiment.

In FIG. 1, the image processing device includes a line memory 1, a defect correcting circuit 2, a digital binning circuit 3, an averaging filter 4, an epsilon filter 5, a frame buffer 6, edge detecting units 7 and 8, a low middle pass image mixing circuit 9, and a low middle high pass image mixing circuit 10. The image processing device can perform a process for each layer of an input image GI and, for example, can perform a process for each RGB of a Bayer array.

The line memory 1 stores the input image GI by a plurality of rows. FIG. 1 exemplifies a case in which the line memory 1 stores an image with four horizontal lines 1H to 4H. Further, an image of a CMOS image sensor can be used as the input image GI. The defect correcting circuit 2 performs defect correction on the input image GI based on image data stored in the line memory 1. FIG. 1 exemplifies a case in which the defect correcting circuit 2 inputs an image of one horizontal line 0H of the input image GI and inputs an image of four horizontal lines 1H to 4H stored in the line memory 1. The digital binning circuit 3 generates a low pass image GL having a low spatial frequency than an input image GI′ by binning the input image GI′ subjected to the defect correction by the defect correcting circuit 2. For example, the digital binning circuit 3 can generate the low pass image GL by binning 64×64 pixels. Here, not five horizontal lines 0H to 4H subjected to the defect correction by the defect correcting circuit 2 but one middle horizontal line 2H is input to the digital binning circuit 3. The frame buffer 6 stores the low pass image GL generated by the digital binning circuit 3. Here, for example, when 64×64 pixels of the input image GI′ are binned, a compression ratio of the low pass image GL can be set to a longitudinal 1/64 and a transverse 1/64, and thus a storage capacity of the low pass image GL can be set to 1/4096 of a storage capacity of the input image GI′. The averaging filter 4 filters the input image GI′ subjected to the defect correction by the defect correcting circuit 2 and generates a middle pass image GM having a higher spatial frequency than the low pass image GL. FIG. 1 exemplifies a case in which the averaging filter 4 averages 5×5 pixels. For example, a Gaussian filter or the like may be used as the middle pass filter, which generates the middle pass image GM, instead of the averaging filter 4. The epsilon filter 5 filters the input image GI′ subjected to the defect correction by the defect correcting circuit 2 and generates a high pass image GH having a higher spatial frequency than the middle pass image GM. FIG. 1 exemplifies a case in which the epsilon filter 5 processes 5×5 pixels. For example, a bilateral filter or the like may be used as the high pass filter generating the high pass image GH instead of the epsilon filter 5. The edge detecting unit 7 detects an edge of the middle pass image GM based on a difference value between the low pass image GL and the middle pass image GM. The edge detecting unit 8 detects an edge of the high pass image GH based on a difference value between a mixed image GLM and the high pass image GH. The low middle pass image mixing circuit 9 mixes the low pass image GL with the middle pass image GM based on the edge of the middle pass image GM and generates the mixed image GLM. The low middle high pass image mixing circuit 10 mixes the mixed image GLM with the high pass image GH based on the age of the high pass image GH.

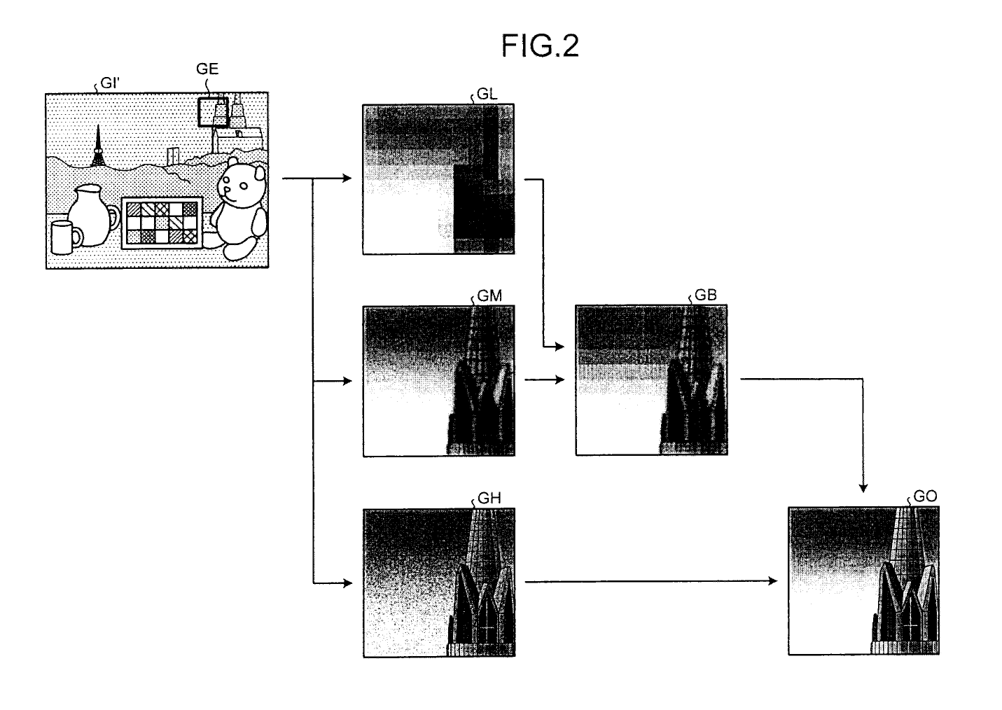

FIG. 2 is a diagram illustrating an image processing method for the image processing device illustrated in FIG. 1.

In FIG. 2, the image of the four horizontal lines 1H to 4H of the input image GI retained in the line memory 1 in FIG. 1 and the image of the one horizontal line 0H of the input image GI are input to the defect correcting circuit 2. Then, the defect correcting circuit 2 performs the defect correction on a central pixel of a predetermined region of the line memory 1 and performs the defect correction of peripheral pixels in the periphery of the central pixel. For example, when the defect correction is performed for each layer, a central pixel in a region of 3×3 pixels as the same color pixels and peripheral pixels are subjected to the defect correction. In the defect correction on the central pixel, it is determined whether the value of the central pixel exceeds a threshold value. When the value of the central pixel exceeds the threshold value, the central pixel is considered as a defect and the value of the central pixel is substituted with the maximum value of the peripheral pixels. In the defect correction on the peripheral pixels, it is determined whether the values of the peripheral pixel exceed a threshold value. When the values of the peripheral pixels exceed the threshold value, the peripheral pixels are considered as defects and the values of the peripheral pixels can be substituted with the maximum value of the peripheral pixel of the same horizontal line. Further, in the defect correction, the CMOS image sensor is selected in advance so that only one defect of the input image GI is present inside the region of 3×3 pixels. When a plurality of defects are present inside the region of 3×3 pixels, the region may be discarded as a defective product in advance.

When the digital binning circuit 3 bins a partial image GE of the input image GI′ subjected to the defect correction by the defect correcting circuit 2, a low pass image GL is generated and stored in the frame buffer 6. When the partial image GE of the input image GI′ is input to the averaging filter 4, a middle pass image GM is generated and output to the edge detecting unit 7 and the low middle pass image mixing circuit 9. When the partial image GE of the input image GI′ is input to the epsilon filter 5, a high pass image GH is generated and output to the edge detecting unit 8 and the low middle high pass image mixing circuit 10.

In the low middle pass image mixing circuit 9, the low pass image GL is selected for a portion in which an edge is not detected by the edge detecting unit 7 and the middle pass image GM is selected for a portion in which the edge is detected by the edge detecting unit 7. Then, the low pass image GL and the middle pass image GM are mixed and a mixed image GLM is output to the low middle high pass image mixing circuit 10.

In the low middle high pass image mixing circuit 10, the mixed image GLM is selected for a portion in which the edge is not detected by the edge detecting unit 8 and the high pass image GH is selected for a portion in which the edge is detected by the edge detecting unit 8. Then, the mixed image GLM and the high pass image GH are mixed, and thus an output image GO is generated.

When the digital binning circuit 3 generates the low pass image GL and stores the low pass image GL in the frame buffer 6, a line memory used to generate the low pass image GL may not be provided, thereby reducing a circuit size. For example, when an image with 4096×3072 pixels is processed, the capacity of the line memory corresponding to 4096×63 pixels is required to generate the low pass image GL. On the other hand, when a compression ratio of the low pass image GL is set to a longitudinal 1/64 and a transverse 1/64 to perform the process, only the capacity of the frame buffer 6 corresponding to 64×48 pixels is necessary.

When the line memory 1 for the defect correction is used to generate the middle pass image GM and the high pass image GH, a line memory used to generate the middle pass image GM and the high pass image GH may not be provided, thereby reducing the circuit size. Further, by performing the defect correction not only on the central pixel but also the peripheral pixels in the periphery of the central pixel in the defect correcting circuit 2, an image quality can be improved.

### Second Embodiment

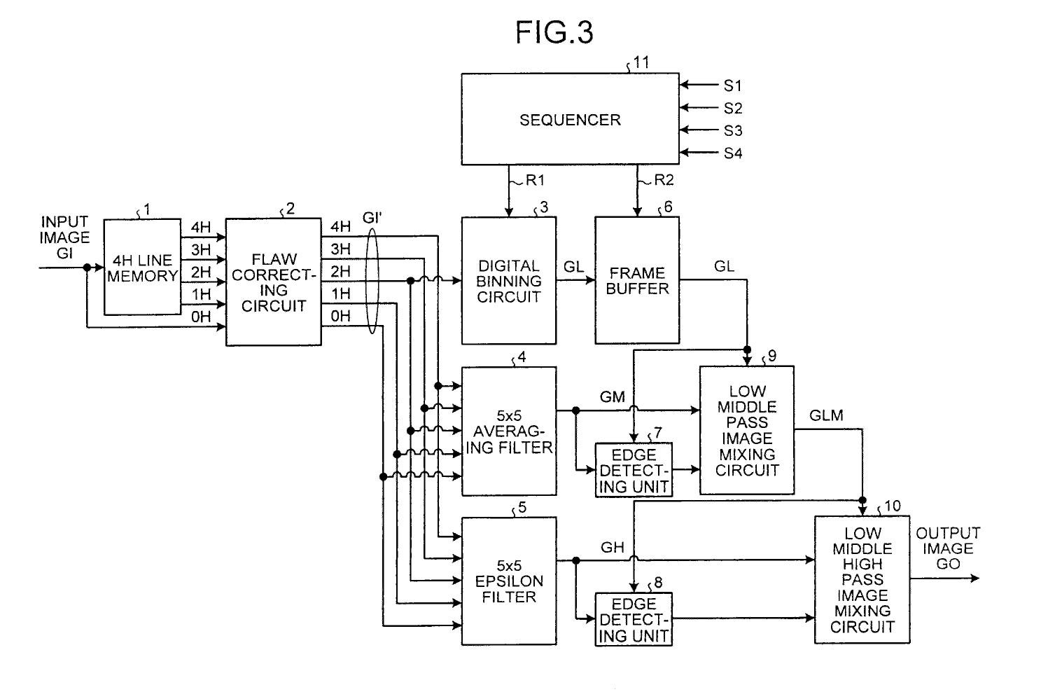

FIG. 3 is a block diagram illustrating an overall configuration of an image processing device according to a second embodiment.

In the image processing device illustrated in FIG. 3, a sequencer 11 is added to the configuration of the image processing device in FIG. 1. The sequencer 11 controls use of the low pass image GL in the low middle pass image mixing circuit 9 based on correlation between input images GI. Based on the correlation between the input images GI, for example, images before and after zooming, images before and after standby, images before and after upper and lower reversing, or images before and after cutout can be determined. The correlation between the input images GI can be given as a synchronization signal S1, a mask signal S2, a reset signal S3, and image mode information S4 from the outside to the sequencer 11.

The synchronization signal S1 indicates an output enable signal of the input image GI. The mask signal S2 indicates whether the input image GI is a stop image. When the mask signal S2 is set to be active, the synchronization signal S1 is masked and the output of the input image GI is stopped. The reset signal S3 indicates a transition instruction signal to a standby state. The image mode information S4 can include binning information on the input image GI, flip information on the input image GI, and width height information on the input image GI.

The sequencer 11 outputs a binning control signal R1 to the digital binning circuit 3 and outputs a buffer control signal R2 to the frame buffer 6. The sequencer 11 determines the correlation between the input images GI based on the synchronization signal S1, the mask signal S2, the reset signal S3, and the image mode information S4. When there is the correlation between the input images GI, a binning ratio of the digital binning circuit 3 is controlled based on the binning control signal R1 according to a compression ratio of the input image GI so that a compression ratio of the low pass image GL is constant. The compression ratio of the input image GI can be determined from the binning information included in the image mode information S4. The frame buffer 6 is controlled based on the buffer control signal R2, the previous low pass image GL stored in the frame buffer 6 is retained without change, and the low pass image GL is output to the low middle pass image mixing circuit 9. When the input image GI is changed over, the low middle pass image mixing circuit 9 mixes the previous low pass image GL stored in the frame buffer 6 with the currently generated middle pass image GM to generate a mixed image GLM.

Here, by controlling the binning ratio of the digital binning circuit 3 so that the compression ratio of the low pass image GL is constant, the previous low pass image GL stored in the frame buffer 6 and the currently generated middle pass image GM are mixed to generate a mixed image GLM, even when the compression ratio of the input image GI is changed.

Conversely, when there is no correlation between the input images GI, the frame buffer 6 is controlled based on the buffer control signal R2 and the previous low pass image GL stored in the frame buffer 6 is discarded. When the input image GI is changed over in the low middle pass image mixing circuit 9, the currently generated middle pass image GM is output as the mixed image GLM to the low middle high pass image mixing circuit 10. Then, the low middle high pass image mixing circuit 10 selects the middle pass image GM for a portion in which the edge is not detected by the edge detecting unit 8, selects the high pass image GH for a portion in which the edge is detected by the edge detecting unit 8, and mixes the middle pass image GM with the high pass image GH to generate an output image GO.

Here, by controlling the digital binning circuit 3 and the frame buffer 6 based on the correlation between the input images GI, noise of the input image GI can be removed while achieving rapid adaptation to a state change of the input image GI even when the state of the input image GI is changed.

### Third Embodiment

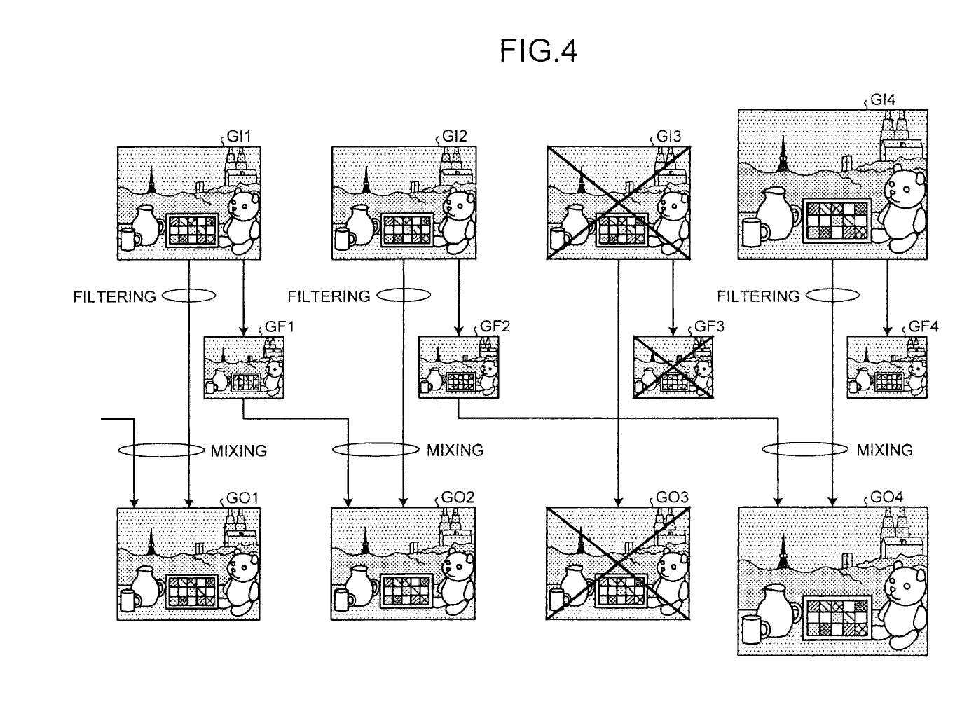

FIG. 4 is a diagram illustrating an image processing method according to a third embodiment.

In FIG. 4, viewfinder images GI1 and GI2 are sequentially input as the input images GI in FIG. 3. For example, a compression ratio of the viewfinder images GI1 and GI2 with respect to a still image GI4 can be set to a longitudinal 1/2 and a transverse 1/2. At this time, the averaging filter 4 and the epsilon filter 5 perform the filtering to generate a middle pass image GM and a high pass image GH, respectively. Further, the digital binning circuit 3 performs binning to sequentially generate low pass images GF1 and GF2 and sequentially stores the low pass images GF1 and GF2 in the frame buffer 6. Here, when a compression ratio of a low pass image GF4 of the still image GI4 is set to a longitudinal 1/64 and a transverse 1/64, the compression ratio of the low pass images GF1 and GF2 can accord with the compression ratio of the low pass image GF4 by setting a binning ratio in the digital binning circuit 3 to a longitudinal 1/32 and a transverse 1/32. The middle pass image GM and the high pass image GH currently generated and the low pass images GF1 and GF2 generated previously by one frame are sequentially mixed to generate output images GO1 and GO2.

When the input image GI is changed from the viewfinder image GI2 to the still image GI4, the sequencer 11 determines correlation between the viewfinder image GI2 and the still image GI4. At this time, the binning information included in the image mode information S4 is updated from the binning ratio of the longitudinal 1/2 and the transverse 1/2 to the same magnification. When the binning information included in the image mode information S4 is updated, it is determined that there is the correlation between the viewfinder image GI2 and the still image GI4. Therefore, the low pass image GF2 stored in the frame buffer 6 is retained without change.

When the input image GI is changed from the viewfinder image GI2 to the still image GI4 and the stop image GI3 is input as the input image GI, the mask signal S2 is set to be active. At this time, the sequencer 11 performs control such that a low pass image GF3 of the stop image GI3 is not stored in the frame buffer 6, and thus an output image GO3 of the stop image GI3 is considered not to be generated.

When the still image GI4 is input as the input image GI, the averaging filter 4 and the epsilon filter 5 perform the filtering to generate a middle pass image GM and a high pass image GH. Then, the middle pass image GM and the high pass image GH currently generated, and the low pass image GF2 stored in the frame buffer 6 are mixed to generate an output image GO4. Further, the digital binning circuit 3 bins the still image GI4 to generate a low pass image GF4 and stores the low pass image GF4 in the frame buffer 6.

By controlling the binning ratio of the digital binning circuit 3 so that the compression ratio of the low pass images GF1 and GF2 accords with the compression ratio of the low pass image GF4, the low pass image GF2 generated from the viewfinder image GI2 can be mixed with the middle pass image GM and the high pass image GH generated from the still image GI4 even when the compression ratios are different between the viewfinder images GI2 and the still image GI4. Therefore, the noise of the input image GI can be removed while achieving the rapid adaptation to the state change of the input image GI.

By determining the correlation between the viewfinder image GI2 and the still image GI4, the low pass image GF2 generated from the viewfinder image GI2 can be used in the generation of the output image GO4 of the still image GI4.

### Fourth Embodiment

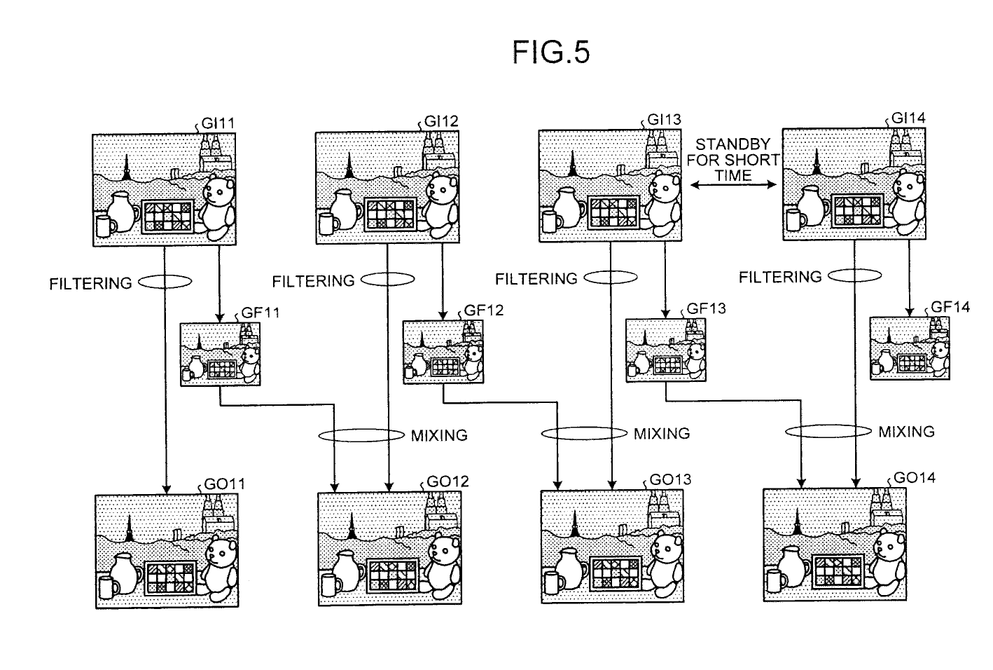

FIG. 5 is a diagram illustrating an image processing method according to a fourth embodiment.

In FIG. 5, input images GI11 to GI13 are assumed to be sequentially input as the input images GI in FIG. 3. At this time, the averaging filter 4 and the epsilon filter 5 perform the filtering to generate a middle pass image GM and a high pass image GH. The digital binning circuit 3 performs binning to sequentially generate low pass images GF11 to GF13 and sequentially stores the low pass images GF11 to GF13 in the frame buffer 6. Then, the middle pass image GM and the high pass image GH currently generated are sequentially mixed with the low pass images GF11 to GF13 generated previously by one frame to generate output images GO11 to GO13.

When standby is performed before input of an input image GI14, the reset signal S3 is set to be active and the sequencer 11 determines a standby time. When the standby time is within a predetermined time, it is determined that there is correlation between the input images GI13 and GI14 and the low pass image GF13 stored in the frame buffer 6 is retained without change.

When the input image GI14 is input as the input image GI, the averaging filter 4 and the epsilon filter 5 perform the filtering to generate a middle pass image GM and a high pass image GH. Then, the middle pass image GM and the high pass image GH currently generated are mixed with the low pass image GF13 stored in the frame buffer 6 to generate an output image GO14. The digital binning circuit 3 bins the input image GI14 to generate a low pass image GF14 and stores the low pass image GF14 in the frame buffer 6.

Here, when a standby time before the input of the input image GI14 is within a predetermined time, the low pass image GF13 stored in the frame buffer 6 is retained without change. Then, while preventing reproduction of the output image GO14 of the input image GI14 from being damaged, the low pass image GF13 generated from the input image GI13 can be used in the generation of the output image GO14 of the input image GI14.

### Fifth Embodiment

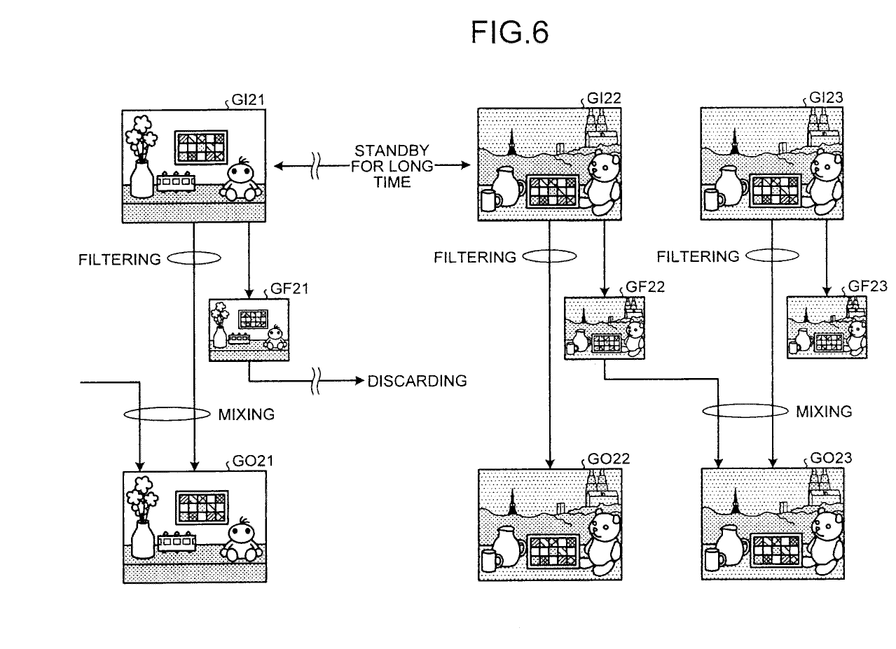

FIG. 6 is a diagram illustrating an image processing method according to a fifth embodiment.

In FIG. 6, an input image GI21 is assumed to be input as the input image GI in FIG. 3. At this time, the averaging filter 4 and the epsilon filter 5 perform the filtering to generate a middle pass image GM and a high pass image GH. The digital binning circuit 3 performs binning to generate a low pass image GF21 and stores the low pass image GF21 in the frame buffer 6. The middle pass image GM and the high pass image GH currently generated are mixed with a low pass image generated previously by one frame to generate an output image GO21.

When standby is performed before input of the input image GI22, the reset signal S3 is set to be active and the sequencer 11 determines a standby time. When the standby time exceeds a predetermined time, it is determined that there is no correlation between the input images GI21 and GI22 and the low pass image GF21 stored in the frame buffer 6 is discarded.

When the input image GI22 is input as the input image GI, the averaging filter 4 and the epsilon filter 5 perform the filtering to generate the middle pass image GM and the high pass image GH and then a mixed image thereof is output as an output image GO22. The digital binning circuit 3 bins the input image GI22 to generate a low pass image GF22 and stores the low pass image GF22 in the frame buffer 6.

Next, when an input image GI23 is input as the input image GI, the averaging filter 4 and the epsilon filter 5 perform the filtering to generate a middle pass image GM and a high pass image GH. Then, the middle pass image GM and the high pass image GH currently generated are mixed with the low pass image GF22 stored in the frame buffer 6 to generate an output image GO23. The digital binning circuit 3 bins the input image GI23 to generate a low pass image GF23 and stores the low pass image GF23 in the frame buffer 6.

Here, when the standby time before the input of the input image GI22 exceeds the predetermined time, the low pass image GF22 stored in the frame buffer 6 is discarded. Then, since the low pass image GF21 generated from the input image GI21 may not be used in the generation of the output image GO22 of the input image GI22, the reproduction of the output image GO22 of the input image GI22 can be prevented from being damaged.

### Sixth Embodiment

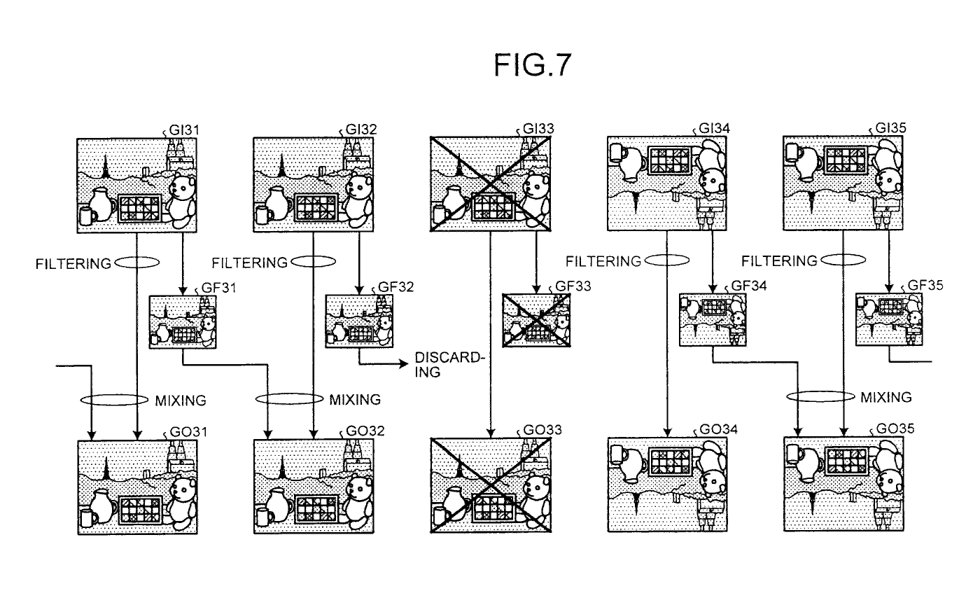

FIG. 7 is a diagram illustrating an image processing method according to a sixth embodiment.

In FIG. 7, non-flip images GI31 and GI32 are assumed to be sequentially input as the input images GI in FIG. 3. At this time, the averaging filter 4 and the epsilon filter 5 perform the filtering to generate a middle pass image GM and a high pass image GH, respectively. The digital binning circuit 3 performs binning to sequentially generate low pass images GF31 and GF32 and sequentially stores the low pass images GF31 and GF32 in the frame buffer 6. Then, the middle pass image GM and the high pass image GH currently generated are sequentially mixed with the low pass images GF31 and GF32 generated previously by one frame to generate output images GO31 and GO32.

When the input image GI is changed from the non-flip image GI32 to the upper and lower flip image GI34, the sequencer 11 determines the correlation between the non-flip image GI32 and the upper and lower flip image GI34. At this time, the flip information included in the image mode information S4 is updated from the non-flip image to the upper and lower flip image. When the flip information included in the image mode information S4 is updated, it is determined that there is no correlation between the non-flip image GI32 and the upper and lower flip image GI34, and thus the low pass image GF32 stored in the frame buffer 6 is discarded.

When the input image GI is changed from the non-flip image GI32 to the upper and lower flip image GI34 and a stop image GI33 is input as the input image GI, the mask signal S2 is set to be active. At this time, the sequencer 11 performs control such that the low pass image GF33 of the stop image GI33 is not stored in the frame buffer 6 and an output image GO33 of the stop image GI33 is considered not to be generated.

When the upper and lower flip image GI34 is input as the input image GI, the averaging filter 4 and the epsilon filter 5 perform the filtering to generate a middle pass image GM and a high pass image GH and then a mixed image thereof is output as an output image GO34. The digital binning circuit 3 bins the upper and lower flip image GI34 to generate a low pass image GF34 and stores the low pass image GF34 in the frame buffer 6.

Next, when the upper and lower flip image GI35 is input as the input image GI, the averaging filter 4 and the epsilon filter 5 perform the filtering to generate a middle pass image GM and a high pass image GH. Then, the middle pass image GM and the high pass image GH currently generated are mixed with the low pass image GF34 stored in the frame buffer 6 to generate an output image GO35. The digital binning circuit 3 bins the input image GI35 to generate a low pass image GF35 and stores the low pass image GF35 in the frame buffer 6.

When the input image GI is changed from the non-flip image GI32 to the upper and lower flip image GI34, the low pass image GF32 stored in the frame buffer 6 is discarded. Then, since the low pass image GF32 generated from the non-flip image GI32 may not be used in the generation of the output image GO34 of the upper and lower flip image GI34, reproduction of the output image GO34 of the upper and lower flip image GI34 can be prevented from being damaged.

In the embodiment of FIG. 7, the upper and lower reversing has been exemplified, but the same can be applied also to right and left reversing.

### Seventh Embodiment

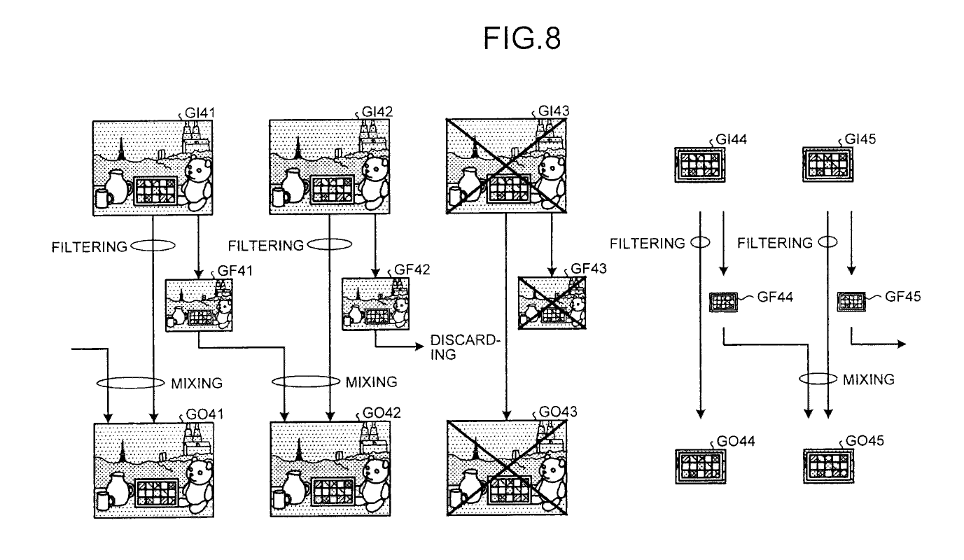

FIG. 8 is a diagram illustrating an image processing method according to a seventh embodiment.

In FIG. 8, input images GI41 and GI42 are assumed to be sequentially input as the input images GI in FIG. 3. At this time, the averaging filter 4 and the epsilon filter 5 perform the filtering to generate a middle pass image GM and a high pass image GH, respectively. The digital binning circuit 3 performs binning to sequentially generate low pass images GF41 and GF42 and sequentially stores the low pass images GF41 and GF42 in the frame buffer 6. Then, the middle pass image GM and the high pass image GH currently generated are sequentially mixed with the low pass images GF41 and GF42 generated previously by one frame to generate output images GO41 and GO42.

When the input image GI is changed from the input image GI42 to a cutout image GI44, the sequencer 11 determines correlation between the input image GI42 and the cutout image GI44. At this time, width height information included in the image mode information S4 is updated. When the width height information included in the image mode information S4 is updated, it is determined that there is no correlation between the input image GI42 and the cutout image GI44 and the low pass image GF42 stored in the frame buffer 6 is discarded.

When the input image GI is changed from the input image GI42 to the cutout image GI44 and a stop image GI43 is input as the input image GI, the mask signal S2 is set to be active. At this time, the sequencer 11 performs control such that the low pass image GF43 of the stop image GI43 is not stored in the frame buffer 6 and an output image GO43 of the stop image GI43 is considered not to be generated.

When the cutout image GI44 is input as the input image GI, the averaging filter 4 and the epsilon filter 5 perform the filtering to generate a middle pass image GM and a high pass image GH and then a mixed image thereof is output as an output image GO44. The digital binning circuit 3 bins the cutout image GI44 to generate a low pass image GF44 and stores the low pass image GF44 in the frame buffer 6.

Next, when the cutout image GI45 is input as the input image GI, the averaging filter 4 and the epsilon filter 5 perform the filtering to generate a middle pass image GM and a high pass image GH. Then, the middle pass image GM and the high pass image GH currently generated are mixed with the low pass image GF44 stored in the frame buffer 6 to generate an output image GO45. The digital binning circuit 3 bins the input image GI45 to generate a low pass image GF45 and stores the low pass image GF45 in the frame buffer 6.

When the input image GI is changed from the input image GI42 to the cutout image GI44, the low pass image GF42 stored in the frame buffer 6 is discarded. Then, since the low pass image GF42 generated from the input image GI42 may not be used in the generation of the output image GO44 of the cutout image GI44, reproduction of the output image GO44 of the cutout image GI44 can be prevented from being damaged.

### Eighth Embodiment

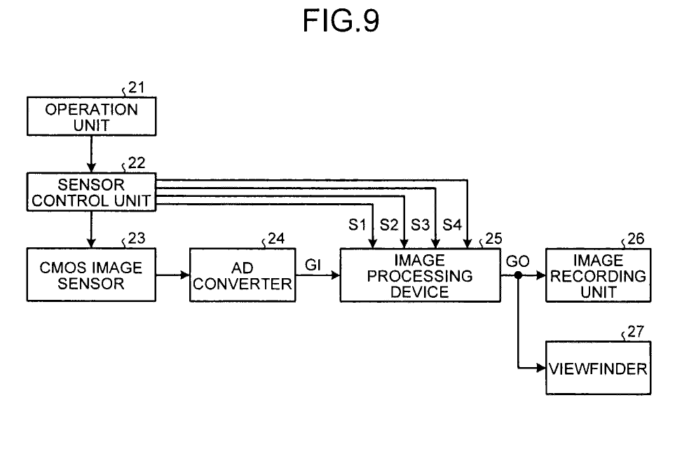

FIG. 9 is a block diagram illustrating an overall configuration of a video camera to which the image processing device according to the eighth embodiment is applied.

In FIG. 9, the video camera includes an operation unit 21, a sensor control unit 22, a CMOS image sensor 23, an AD converter 24, an image processing device 25, an image recording unit 26, and a viewfinder 27. The image processing device 25 can have the configuration illustrated in FIG. 3. The operation unit 21 can perform various kinds of scanning of the video camera. For example, the operation unit 21 can perform still image shot of an image captured in the CMOS image sensor 23, perform standby processing, perform zooming, perform upper and lower reversing, or perform cutting.

The sensor control unit 22 may make the CMOS image sensor 23 to perform still image shot of a captured image, perform standby processing of the captured image, perform zooming on the captured image, perform upper and lower reversing on the captured image, and perform cutting on the captured image. Further, the sensor control unit 22 can output the synchronization signal S1, the mask signal S2, the reset signal S3, and the image mode information S4 to the image processing device 25. The CMOS image sensor 23 can output the captured image. The AD converter 24 digitizes the captured image output from the CMOS image sensor 23 to generate an input image GI. The image recording unit 26 can record an output image GO output from the image processing device 25. The viewfinder 27 can display the output image GO output from the image processing device 25.

When a user operates the operation unit 21, the CMOS image sensor 23 performs the still image shot of a captured image, performs the standby processing of the captured image, performs the zooming on the captured image, performs the upper and lower reversing on the captured image, or performs the cutting on the captured image. Then, after the captured image is digitized by the AD converter 24, the digitized image is input as the input image GI to the image processing device 25. The image processing device 25 multiplexes a low pass image GL, a middle pass image GM, and a high pass image GH based on the correlation between the input images GI to generate the output image GO, and then the output image GO is recorded in the image recording unit 26 or is displayed on the viewfinder 27.

In the above-described embodiments, the method of multiplexing the low pass image GL, the middle pass image GM, and the high pass image GH generated from the input image GI has been described. However, the images to be multiplexed may not be limited to three spatial frequency bands. Two low and high spatial frequency bands, or four or more spatial frequency bands may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a line memory that stores an input image by a plurality of rows;
a binning circuit that generates a low pass image having a lower spatial frequency than the input image by binning the input image;
a frame buffer that stores the low pass image;
a filter that generates a high pass image having a higher spatial frequency than the low pass image by filtering the input image stored in the line memory;
a mixing circuit that mixes the low pass image with the high pass image; and
a sequencer that controls use of the low pass image in the mixing circuit based on correlation between the input images.

2. The image processing device according to claim 1, wherein the sequencer determines the correlation between the input images based on a synchronization signal, a mask signal, a reset signal, and image mode information.

3. The image processing device according to claim 2, wherein the image mode information includes binning information on the input image, flip information on the input image, and width height information on the input image.

4. The image processing device according to claim 2, wherein the synchronization signal, the mask signal, the reset signal, and the image mode information are given from a CMOS image sensor outputting the input image.

5. The image processing device according to claim 1, wherein, when there is the correlation between the input images, the sequencer retains the low pass image before change of the input image in the frame buffer and makes the mixing circuit to use the low pass image before the change of the input image after the input image is changed.

6. The image processing device according to claim 1, wherein, when there is no correlation between the input images, the sequencer discards the low pass image provided before the change of the input image from the frame buffer and makes the mixing circuit not to use the low pass image before the change of the input image after the input image is changed.

7. The image processing device according to claim 1, wherein the sequencer controls a compression ratio of the binning circuit according to a compression ratio of the input image so that a compression ratio of the low pass image is constant.

8. The image processing device according to claim 6, wherein the sequencer retains the low pass image before the change of the input image in the frame buffer and makes the mixing circuit to use the low pass image before the change of the input image after the input image is changed.

9. The image processing device according to claim 1, wherein, when a stop image is designated as the input image, the sequencer does not store a low pass image of the stop image in the frame buffer.

10. The image processing device according to claim 9, wherein, when the stop image is designated as the input image, the sequencer makes the mixing circuit not to use the low pass image of the stop image.

11. The image processing device according to claim 1, wherein, when standby within a predetermined time is designated at the time of the input of the input image, the sequencer retains the low pass image provided before the standby in the frame buffer and makes, after the standby, the mixing circuit to use the low pass image provided before the standby.

12. The image processing device according to claim 1, wherein, when standby exceeding a predetermined time is designated at the time of the input of the input image, the sequencer discards the low pass image provided before the standby from the frame buffer.

13. The image processing device according to claim 12, wherein, when the standby exceeding the predetermined time is designated at the time of the input of the input image, the sequencer makes the mixing circuit not to use the low pass image provided before the standby.

14. The image processing device according to claim 1, wherein, when a flip image is designated as the input image, the sequencer discards the low pass image of a non-flip image retained in the frame buffer.

15. The image processing device according to claim 14, wherein, when the flip image is designated as the input image, the sequencer makes the mixing circuit not to use the low pass image of the non-flip image retained in the frame buffer.

16. The image processing device according to claim 1, wherein, when a cutout image is designated as the input image, the sequencer discards a low pass image of an original image retained in the frame buffer.

17. The image processing device according to claim 16, wherein, when the cutout image is designated as the input image, the sequencer makes the mixing circuit not to use the low pass image of the original image retained in the frame buffer.
